(19) United States
(12) Patent Application Publication
(10) Pub. No.: US 2006/0178202 A1
(43) Pub. Date: Aug. 10, 2006

(54) Virtual tournament establishment in a wagering game environment

(76) Inventors: Darryl Hughes, River Forest, IL (US); Joel R. Jaffe, Glenview, IL (US); Jason Smith, Arlington Heights, IL (US); William R. Wadleigh, Lisle, IL (US)

Correspondence Address: Daniel J. Burnham;JENKENS & GILCHRIST, A PROFESSIONAL CORPORATION, Ste. 2600, 225 W. Washington, Chicago, IL, 60606-3418, US

(21) Appl. No.: 11/293,926

(22) Filed: Dec. 5, 2005

Related U.S. Application Data
(60) Provisional application No. 60/633,528, filed on Dec. 6, 2004.

(51) Int. Cl. A63F 13/00

(52) U.S. Cl. 463/20

(57) ABSTRACT

According to one embodiment of the present invention, a method of offering a wagering game tournament is disclosed. The wagering game tournament is offered to a plurality of players playing on a gaming network. A wager is received from both a first player at a first gaming terminal and a second player at a second gaming terminal to play a first and second standard wagering game, respectively. The second standard wagering game is a different wagering game from the first standard wagering game. The standard game is initiated and an option is provided to each of the players to enter a tournament mode. A wagering game tournament is initiate and the players are able to enroll in the tournament, after the player has selected the tournament mode option.

### CROSS REFERENCE TO RELATED APPLICATIONS

This application claims the benefit of priority of U.S. Provisional Patent Application No. 60/633,528, filed Dec. 6, 2004, which is hereby incorporated by reference in its entirety.

### FIELD OF THE INVENTION

The present invention relates generally to wagering games and, more particularly, to a method for creating virtual tournaments between terminals operating wagering games.

### BACKGROUND OF THE INVENTION

Gaming terminals, such as slot machines, video poker machines and the like, have been a cornerstone of the gaming industry for many years. Generally, the popularity of such machines with players is dependent on the likelihood (or perceived likelihood) of winning money at the gaming terminal and the intrinsic entertainment value of the machine relative to other available gaming options. Where the available gaming options include a number of competing machines and the expectation of winning on each machine is roughly the same (or believed to be the same), players are most likely to be attracted to the most entertaining and exciting machines. Shrewd operators constantly strive to employ the most entertaining and exciting machines available, because such machines attract frequent play and hence increase profitability to the operator.

Classically, a stand-alone gaming terminal allows a player to compete against the wagering game itself, and hence, the odds associated with the particular game. With the introduction of progressive jackpots, players have the option to wager on a terminal having an increasing, and eventually, quite large jackpot. This increasing jackpot provided more excitement to the player by establishing a very large potential payout for a standard wager. Gaming terminals having a progressive jackpot feature are linked to a large number of identical gaming terminals in a single location or multiple locations, in a single geographic area or worldwide. However, as with the stand-alone terminals, the player still feels like they are competing only with the wagering game itself.

Thus, a need exists for a system that allows players at a gaming terminal to compete against one or more players, instead of simply competing against the wagering game itself.

### SUMMARY OF THE INVENTION

According to one embodiment of the present invention, a method of offering a wagering game tournament to a plurality of players on a plurality of gaming terminals located on a gaming network is disclosed. The method includes receiving a wager from a first player to play a first standard wagering game on a first gaming terminal and receiving a wager from a second player to play a second standard wagering game on a second gaming terminal. The second standard wagering game is a different wagering game than the first standard wagering game. The method further includes initiating the standard wagering games on the gaming terminals and providing an option, at the gaming terminals, to the plurality of players to enter a tournament mode. The method further includes initiating the wagering game tournament and providing the ability to enroll in the tournament once the tournament has been initiated, after the player has selected the tournament mode option.

According to another embodiment of the present invention, a method for conducting a wagering game tournament is disclosed. The method includes forming a first team including one or more wagering game player, where each of the one or more wagering game player interacting with a wagering game displayed on a gaming terminal. The method further includes forming a second team including one or more wagering game player, where each of the one or more wagering game player interacting with a wagering game displayed on a gaming terminal. The method further includes forming the wagering game tournament by placing the first team and the second team in competition with one another. The wagering game tournament includes at least two different wagering games. The method further includes tracking at least one feature of the wagering games being interacted with by the players. The at least one tracked feature is tracked for both the first team and the second team. The method further includes comparing the tracked at least one feature for the first team to the tracked at least one feature for the second team to determine the team that has the greatest number of tracked at least one feature. The method further includes providing an award to each of the at least one player on the team that has the greatest number of the tracked at least one feature.

According to yet another embodiment of the present invention, a method for establishing a wagering game tournament is disclosed. The method includes receiving a first wager from at least a first player to play a first wagering game and a second wager from at least a second player to play a second wagering game. The second wagering game is a different wagering game than the first wagering game. The method further includes initiating the wagering game tournament after the first and second wagers have been received. The method further includes forming a first team including at least the first player and a second team including at least the second player. The method further includes tracking at least one feature of the first wagering game and the second wagering game. The at least one feature is the same for both the first and second wagering games. The method further includes combining all of the tracked at least one feature for each of the at least the first player on the first team and all of the tracked at least one feature for each of the at least the second player on the second team. The method further includes comparing the tracked at least one feature for the first team to the tracked at least one feature for the second team to determine the team that has the greatest number of tracked at least one feature and providing an award to each player on the team that has the greatest number of the tracked at least one feature.

The above summary of the present invention is not intended to represent each embodiment, or every aspect, of the present invention. Additional features and benefits of the present invention are apparent from the detailed description, figures, and claims set forth below.

### BRIEF DESCRIPTION OF THE DRAWINGS

FIG. 1 is a perspective view of a gaming terminal according to one embodiment of the present invention.

FIG. 2 illustrates a control system that is used in conjunction with the gaming terminal of FIG. 1.

FIG. 3 is an image of a basic game screen of a first standard wagering game that is displayed on the gaming terminal of FIG. 1, according to one embodiment of the present invention.

FIG. 4 is an image of a bonus game screen for the first standard wagering game.

FIG. 5 is an image of a basic game screen of a second standard wagering game that may be displayed on a gaming terminal, according to one embodiment.

FIG. 6 is an image of a bonus game screen for the second standard wagering game.

FIG. 7 is a flowchart illustrating the entrance into a wagering game tournament by a player on the gaming terminal of FIG. 1, according to one embodiment of the present invention.

FIG. 8a is an diagram illustrating the tournament types offered by a plurality of wagering games located on a gaming network, according to one embodiment of the present invention.

FIG. 8b is an diagram illustrating the tournament types offered by a plurality of wagering games located on a gaming network, according to one embodiment of the present invention.

FIG. 8c is an diagram illustrating the tournament types offered by a plurality of wagering games located on a gaming network, according to one embodiment of the present invention.

FIG. 9 is an image of a bonus game screen of a bonus wagering game during a tournament, according to one embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE ILLUSTRATED EMBODIMENTS

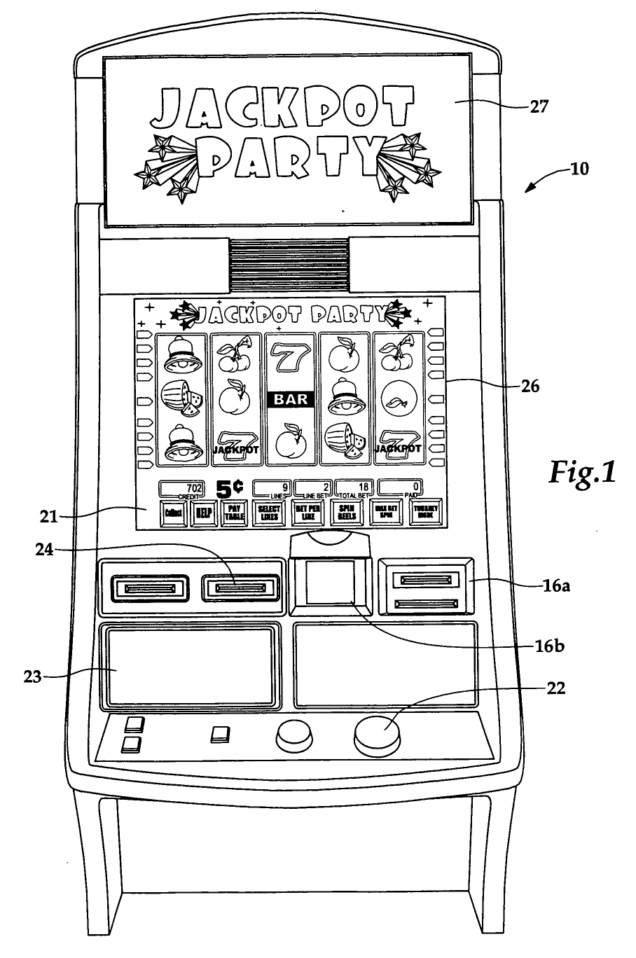

Turning now to the drawings, FIG. 1 is a perspective view of a gaming terminal 10 according to one embodiment of the present invention. The gaming machine 10 is operable to conduct a wagering game. With regard to the present invention, the gaming terminal 10 may be any type of gaming terminal and may have varying structures and methods of operation.

The gaming terminal 10 includes input devices, such as a wager acceptor 16, a touch screen 21, a push-button panel 22, and a player-identification card reader 24. For outputs, the gaming terminal 10 includes a payout mechanism 23, a main display 26 for displaying information about a basic wagering game such as video poker and a secondary display 27 for displaying additional information, and an output receptacle 28 coupled to the payout mechanism 23 for providing tokens or coins to the player when the player selects to cash out. While these typical components found in the gaming terminal 10 are described below, it should be understood that numerous other elements may exist and may be used in any number of combinations to create various forms of a gaming terminal.

The wager acceptor 16 may be provided in many forms, individually or in combination. The wager acceptor 16 may include one or both of a coin slot acceptor or a currency note acceptor to input value to the gaming terminal 10. Additionally, the wager acceptor 16 may include a card-reading device for reading a card that has a recorded monetary value with which it is associated. The card may also authorize access to a central account, which can transfer money to the gaming terminal 10.

The payout mechanism 23 performs the reverse functions of the wager acceptor 16. For example, the payout mechanism 23 may include a coin dispenser or a note dispenser to output value from gaming terminal 10. Also, the payout mechanism 23 may be adapted to receive a card that authorizes the gaming terminal to transfer credits from the gaming terminal 10 to a central account.

The push button panel 22 is typically offered, in addition to the touch screen 21, to provide players with an option of how to make their game selections. Alternatively, the push button panel 22 provides inputs for one aspect of operating the game, while the touch screen 21 allows for inputs needed for another aspect of operating the game.

The operation of the basic wagering game is displayed to the player on the main display 26. The main display 26 and the secondary display 27 may take the form of a cathode ray tube (CRT), a high resolution LCD, a plasma display, LED, or any other type of video display suitable for use in the gaming terminal 10. As shown, the main display 26 includes a touch screen 21 overlaying the entire monitor (or a portion thereof) to allow players to make game-related selections. Similarly, a touch screen may overlay the secondary display 27.

The player-identification card reader 24 allows for the identification of a player by reading a card with information indicating the player's true identity. Currently, the identification is used by casinos for rewarding certain players with complimentary services or special offers. For example, a player may be enrolled in the gaming establishment's players' club and may be awarded certain complimentary services as that player collects points in the player's player-tracking account. The player inserts the player's card into the player-identification card reader 24, which allows the casino's computers to register that player's wagering at the gaming terminal 10.

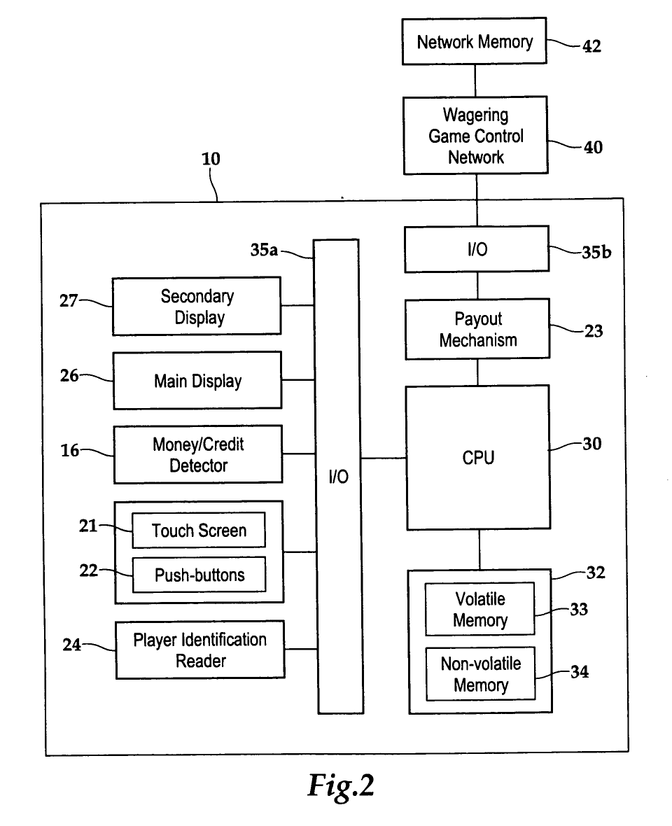

Referring also to FIG. 2, the various components of the gaming terminal 10 are controlled by a central processing unit (CPU) 30 (such as a microprocessor or microcontroller). To provide the gaming functions, the CPU 30 executes a game program. The CPU 30 is also communicatively coupled to or includes a system memory 32. The system memory 32 may comprise a volatile memory 33 (e.g., a random-access memory, “RAM”) and a non-volatile memory 34 (e.g., an EEPROM). It should be appreciated that the CPU 30 may include one or more microprocessors. Similarly, the memory 32 may include multiple RAM and multiple program memories.

Communications between the peripheral components of the gaming terminal 10 and the CPU 30 occur through input/output (I/O) circuits 35a. As such, the CPU 30 also controls and receives inputs from the peripheral components of the gaming terminal 10. Further, the CPU 30 communicates with external systems via the I/O circuits 35b. Although the I/O circuits 35 may be shown as a single block, it should be appreciated that the I/O circuits 35 may include a number of different types of I/O circuits.

The gaming terminal 10 is typically operated as part of a game control network 40 having control circuitry and memory devices, wherein a plurality of gaming terminals are coupled to the game control network 40. The game control network 40 can be the game controller that controls operation of the wagering game as described below. The game control network 40 may optionally include a network memory 42 for alternative storage of data. The network memory 42 may be used, for example, in persistent state gaming, where a feature or asset of the player's game may be saved for future use when the player returned for a later gaming session at a different gaming terminal that is also connected to the network 40. The network memory 42 can include instructions for playing games, such as, progressive jackpots that are contributed to by all or some of the gaming terminals 10 in the network 40.

The processor, memory, or both may be remotely located on the game control network 40. For example, instead of the CPU 30, the game control network 40 may determine the random outcomes for games conducted on the gaming terminal(s) 10. Alternatively, the CPU 30 randomly determines the game outcomes.

The gaming terminal 10 often has multiple serial ports, each port dedicated to providing data to a specific host computer system that performs a specific function (e.g., accounting system, player-tracking system, etc.). To set up a typical serial communication hardware link to the host system, the typical RS-232 point-to-point communication protocol that is often present in the gaming terminal 10 is converted to an RS-485 (or RS-485-type) master-slave protocol so as to take advantage of some of the benefits of the RS-485 capability (e.g., multi-drop capability that allows many gaming terminals 10 to communicate with the game control network 40). To perform this function, a custom interface board may be used by the gaming terminal 10 for each communication port in the gaming terminal 10. It should be noted that the gaming terminal 10 can initially be designed to be configured for a typical RS-485 protocol, instead of the typical RS-232 protocol. Further, the gaming terminal 10 may simply be designed for an Ethernet connection to the game control network 40.

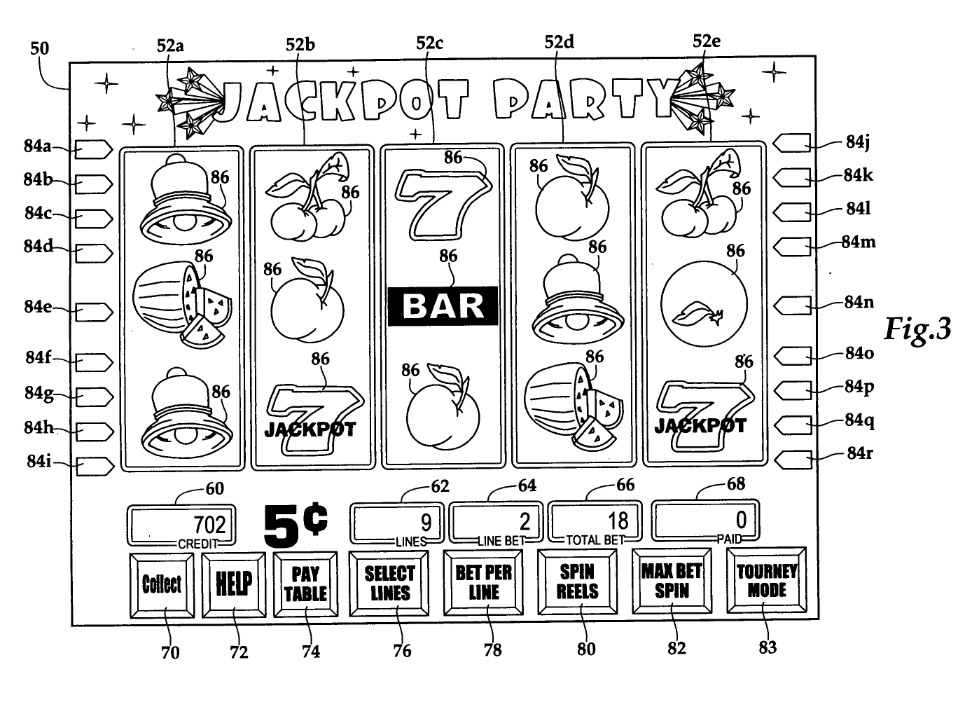

Referring now to FIG. 3, an image of a basic game screen 50 for a first standard wagering game is shown, according to one embodiment of the present invention. The illustrated game screen 50 is for a variation of the wagering game JACKPOT PARTY™, an example of which is more fully described by U.S. Pat. No. 6,190,255 issued to Thomas et al., which is incorporated herein by reference in its entirety.

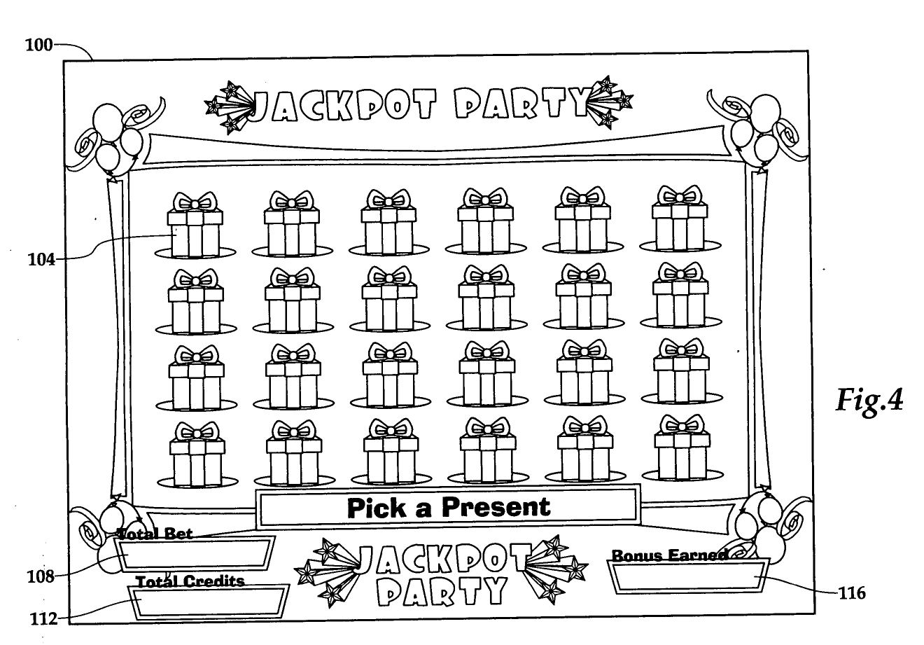

A player begins play of a first standard wagering game by inserting a wager into the wager input accepter 16 of the gaming terminal 10. The first standard wagering game includes a first basic wagering game (illustrated in FIG. 3) and a first bonus game (illustrated in FIG. 4). When a player inserts their wager, the first basic wagering game is initiated. A player can select to play the basic wagering game by either using the touch screen 21 or push-button panel 22 (FIG. 1). The CPU 30, or the wagering game control network 40 in alternative embodiments, operates to execute a wagering game program causing the main video display 26 to display the first basic wagering game that includes a plurality of visual elements.

The basic game screen 50 may be displayed on the main video display 26 or on a portion thereof. In the illustrated embodiment, the basic game screen 50 is used to display a plurality of simulated, movable reels 52a-e with symbols 86 displayed thereon. The reels 52a-e are positioned such that the symbols 86 are displayed relative to at least one payline 84, yielding a plurality of outcomes for the basic game. The basic game screen 50 may also display a plurality of game session meters and various buttons selectable by a player. The game session meters include a “credit” meter 60 for displaying a number of credits available for play on the machine; a “lines” meter 62 for displaying a number of paylines to be played by a player on the machine; a “line bet” meter 64 for displaying a number of credits wagered (e.g., from 1 to 5 credits) for each of the number of paylines played; a “total bet” meter 66 for displaying a total number of credits wagered for the particular round of wagering; and a “paid” meter 68 for displaying an amount to be awarded based on the results of the particular rounds wager. The user-selectable buttons include a “collect” button 70 to collect the credits remaining in the credits meter 60; a “help” button 72 for viewing instructions on how to play the wagering game; a “pay table” button 74 for viewing a pay table associated with the basic wagering game; a “select lines” button 76 for changing the number of paylines (displayed in the lines meter 62) a player wishes to play; a “bet per line” button 78 for changing the amount of the wager which is displayed in the line bet meter 64; a “spin reels” button 80 for moving the reels 52a-e ; a “max bet spin” button 82 for wagering a maximum number of credits and moving the reels 52a-e of the basic wagering game; and a “tourney mode” button 83 for allowing a player to select to be in tournament mode. While the gaming terminal 10 allows for these types of player inputs, the present invention does not require them and can be used on gaming terminals having more, less, or different player inputs.

In FIG. 3, the five depicted reels 52a-e have a plurality of symbols 86 displayed thereon and at least one activated payline 84 extending from one of the payline indicators 84a-i on the left side of the screen 50 to any one of the payline indicators 84j-r on the right side of the screen 50. The plurality of symbols 86 displayed on the plurality of reels 52a-e are used to indicate a plurality of possible outcomes along each of the activated paylines 84. The symbols 86 may be selected from any number of choices and may represent any number of game themes. Further explanation of the composition of the symbols 86 and/or their potential themes is not required to understand the present invention.

A winning combination occurs when the symbols 86 appearing on the reels 52a-e correspond to one of the winning symbol combinations listed in a pay table stored in the memory 32 of the gaming terminal 10. The pay table may be displayed on the secondary display 27, the main display 26, or both and be either displayed constantly, intermittently, or upon request by a player (e.g., by selecting the pay-table button 74). Such winning combinations are displayed relative to one or more paylines 84. The activated paylines 84 extend between activated pairs of payline indicators 84a-r such as, for example, the payline that extends between payline indicators 84e and 84n. Winning combinations listed in the pay table can include three like-symbols appearing on a payline yielding a first payout, four like-symbols appearing on a payline yielding a second, larger payout, and five like-symbols appearing on a payline yielding a third, even larger payout.

The reels 52a-e may be either traditional mechanical reels or they may be computer-generated images of reels. The payline indicators 84a-r indicate a randomly selected outcome for each payline 84, which is the combination of symbols 86 on the reels 52a-i along the particular payline 84. A player may play multiple paylines 84 by selecting the select-lines button 76 until the desired number of paylines 84 (up to nine in the illustrated embodiment) are displayed. While an embodiment with nine paylines is shown, a gaming terminal 10 with a single payline, or multiple paylines will also work with the present invention. Additionally, though an embodiment with five reels is shown, a gaming terminal 10 with any plurality of reels may also be used in accordance with the present invention.

FIG. 4 illustrates the bonus game included in the first standard wagering game. A bonus game screen 100 is shown, according to one embodiment of the present invention. The bonus game screen 100 includes an array of markers 104 located in a plurality of columns and rows. The bonus game screen 100 may also include a plurality of meters, such as, a “total bet” meter 108 for displaying the number of credits a player has wagered, a “total credits” meter 112 for displaying the total number of credits a player has remaining, and a “bonus earned” meter 116 for displaying the number of credits the player has earned during that particular bonus game session.

The bonus game is entered upon the occurrence of a special start-bonus game outcome in the basic wagering game. In the bonus game, a player selects, one at a time, from an array of markers 104 each associated with a bonus game outcome. Credits are awarded based upon which ones of the markers 104 are selected. The bonus game ends upon selection of a marker 104 associated with an end-bonus outcome but otherwise continues, allowing the player to make further selections and accumulate further credits until encountering an end-bonus outcome.

In one embodiment, a bonus game resource obtained in the basic wagering game may be exercised in the bonus game to affect the bonus game outcome. In one embodiment, for example, where the occurrence of an end-bonus outcome would otherwise end the bonus game, a player having a bonus game resource may exercise the bonus game resource upon encountering an end-bonus outcome to continue playing the bonus game.

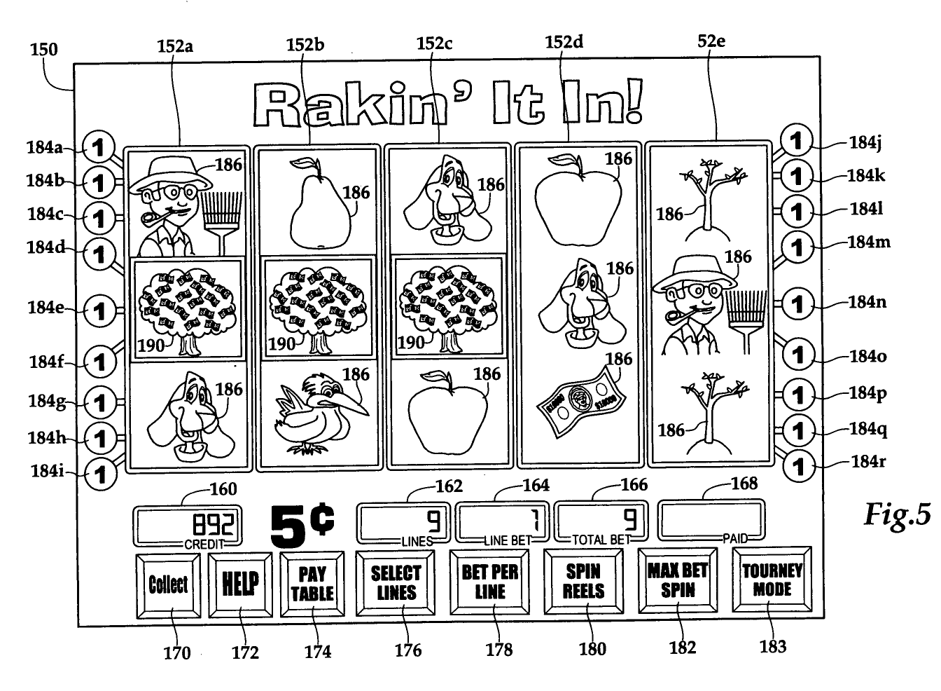

Turning now to FIG. 5, an image of a basic game screen 150 for a second standard wagering game, according to one embodiment of the present invention. The illustrated game screen is for a variation of the wagering game RAKIN' IT IN™, an example of which is more fully described by U.S. patent application Ser. No. 10/368,863 applied for by Jaffe et al., which is incorporated herein by reference in its entirety. According to some embodiments, the second standard wagering game may be displayed on the main display 26 of the gaming terminal 10. In these embodiments, a player begins play of either the first or second standard wagering game by inserting a wager into the wager input accepter 16 of the gaming terminal 10 and then selecting whether to play the first standard wagering game or the second standard wagering game. In other embodiments of the invention, the second standard wagering game is included on a different gaming terminal than the first standard wagering game.

The second standard wagering game's operation and functionality is similar to that described above with respect to the first standard wagering game in FIGS. 3-4. As illustrated, a plurality of symbols 186 located on a plurality of reels 152a-e are displayed on the second basic wagering game screen 150. This provides a plurality of basic game outcomes. Winning combinations for the basic game outcomes can be provided in a pay table that a player can view by, for example, selecting the pay-table button 174. Included among the pluralities of basic game outcomes is a start-bonus outcome for triggering play of a bonus game.

A start-bonus outcome may be defined in any number of ways. For example, a start-bonus outcome may occur when a special start-bonus symbol or a special combination of symbols appears on one or more of the reels 152a-e. The start-bonus outcome may require the combination of symbols to appear along an active payline 184, or may alternatively require that the combination of symbols appear anywhere on the reels 152a-e regardless of whether the symbols are along an active payline 184. Appearance of the appropriate start-bonus outcome causes the CPU 30 to shift operation from the basic game to the bonus game.

In the embodiment illustrated in FIG. 5, the appearance of three Money Tree symbols 190 anywhere on the display is the start-bonus outcome that triggers a bonus game. The start-bonus outcome, however, may be any predetermined outcome.

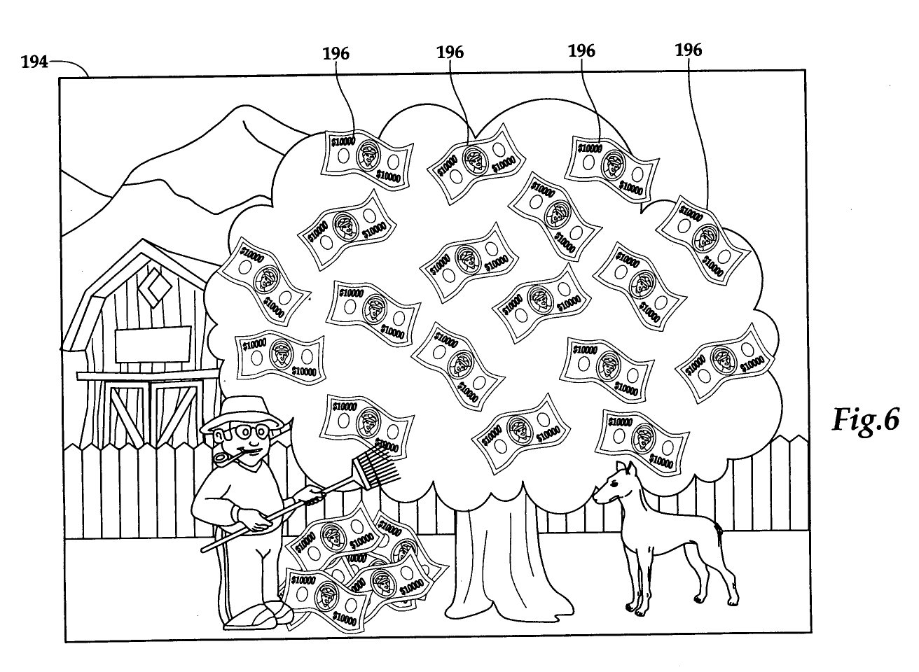

In response to the occurrence of the start-bonus outcome in the basic game, a bonus game commences as depicted in FIG. 6. FIG. 6 depicts a themed bonus game screen 194 where Farmer Mike and his faithful dachshund, Loki, entertain players with their animated antics while players select bills from the Money Tree. The bills are markers 196 that, when selected, reveal a hidden game outcome, such as, a bonus award, among other possibilities. As can be seen from FIG. 6, there are a plurality of these markers from which a player may select.

The above-described first and second standard wagering games have been provided as examples to more fully described the present invention. It should be noted, however, that any number of wagering games may be utilized by the present invention. For example, the standard wagering game need not have both a basic game and a bonus game. Additionally, the wagering game is not limited to a slot-type game and may be, for example, a video poker game, blackjack game, roulette game, keno game, bingo game, etc.

According to some embodiments of the present invention, special reels may be substituted for the standard reels 52a-e,152a-e provided on the basic wagering game once a tournament has been initiated. The substitute reels may contain more or less types of symbols 86,186, different symbols, or special tournament-only symbols. The substitute reels may also be used to handicap the wagering games participating in the tournament, when the wagering games are different. For example, the substitute reels may be used to adjust the volatility of one or more of the games to even the playing field between the competing teams.

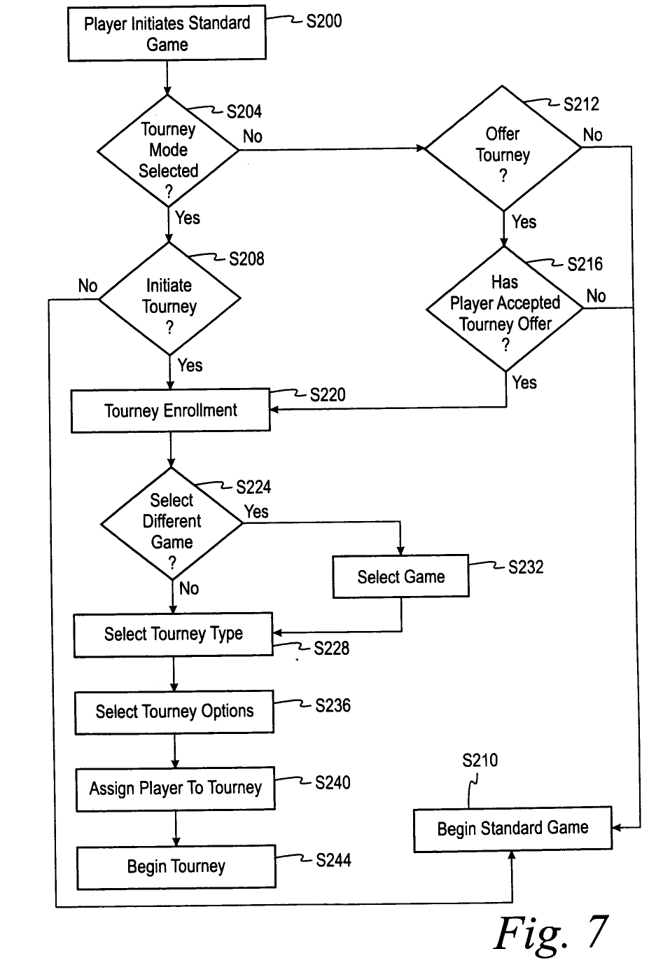

FIG. 7 is a flowchart illustrating the entrance into a tournament by a player on the gaming terminal 10, according to one embodiment of the present invention. A player initiates the standard game, at step s200, by any conventional method (e.g., inserting coins or using credits). Once a standard game has been initiated, the game control network 40, or alternatively the CPU 30, or both, determine, at decision box s204, whether the player has selected to enter tournament mode. The player may choose to enter tournament mode, for example, by selecting the tournament mode button 83,183 located on the basic game screen 50,150.

If the player has not selected to enter tournament mode, a determination is made, at decision box s212, whether to offer an opportunity to join a tournament to the player. This decision may be based on such factors as, for example, whether a requisite number of players are available, whether a predetermined amount of time has passed since the last tournament or offer for a tournament, whether a predetermined number of credits have been wagered, whether a predetermined number of bonuses have been earned, or whether a special tournament bonus has been earned. If the determination at decision box s212 is no, the standard game is begun for the player, at step 210. If, however, an opportunity to join a tournament is to be offered, a determination is made, at decision box s216, as to whether the player has accepted the offer. If the player declines the offer to join the tournament, the standard game is begun for the player, at step s210. Alternatively, if the player accepts the tournament offer, the player is enrolled in the tournament, at step s220.

Referring again to decision box s204, if a determination is made that the player has selected to enter tournament mode, another determination is then made, at decision box s208, whether to initiate a tournament. This determination can be made on the same, or additional, factors that served as examples for whether to offer a tournament at decision box s212. If, at decision box s208, the determination is made not to initiate a tournament, the standard game is begun for the player, at step s210. Alternatively, if the decision is made to initiate a tournament, at decision box s208, the player is enrolled in the tournament, at step s220.

To enroll in a tournament, the player may be provided a plurality of options to select. These options may then be used to establish the tournament that the player will be enrolled in. For example, according to one embodiment of the invention, the player may be allowed to select a different game to wager on than the original game the player initiated, at step s200. In this embodiment, a determination is made, at decision box s224, as to whether the player wishes to select a different game. If the player chooses to select a different game, the player is allowed to select a different game from an available games list (displayed on the main display 26 in FIG. 1), at step s232. Once the player selects a game, at step s232, or if a determination is made not to select a different game, at decision box s224, the player may be allowed to select the type of tournament to participate in, at step s228.

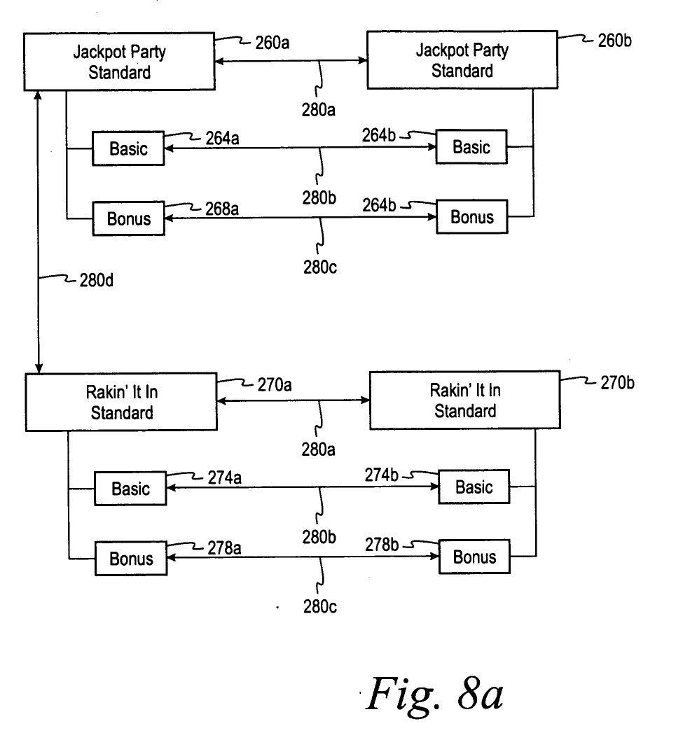

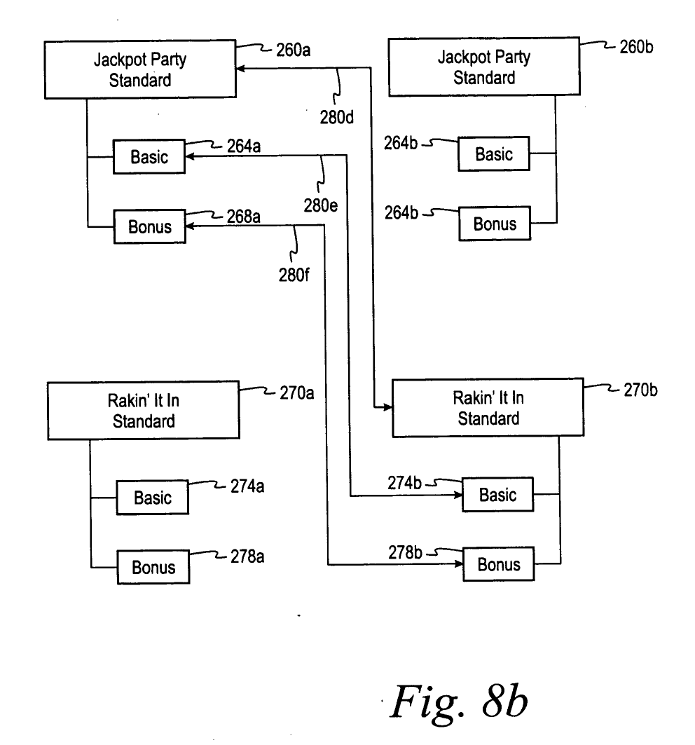

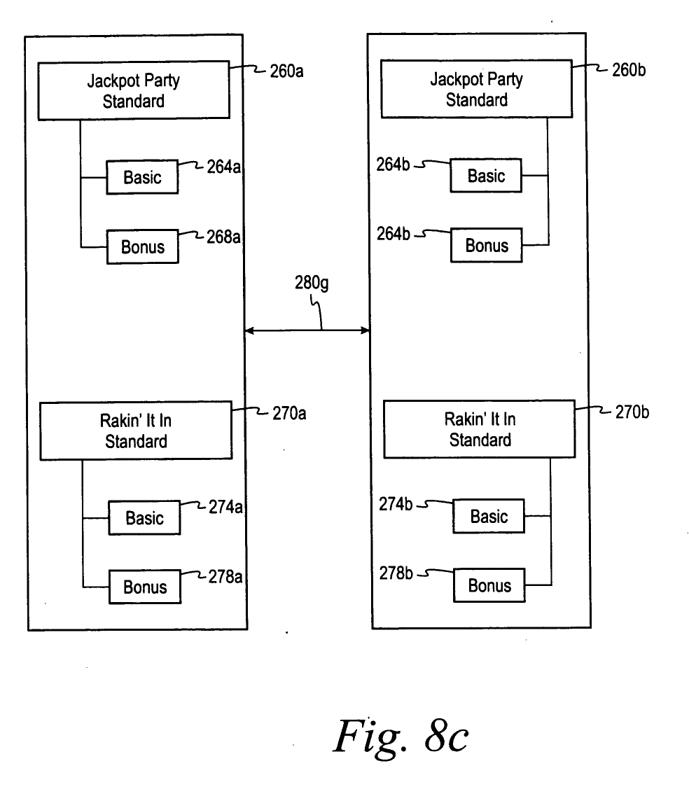

If the tournament type has not been pre-selected by the network 40 or the CPU 30, the player may be allowed to select, at step s228, from the available tournament types, which may be displayed on the main display 26 (FIG. 1). The available tournament types may be, for example, a 1 on 1, 2 on 2, etc. tournament, a first wagering game versus the same wagering game, a first wagering game versus a second wagering game, a bonus game versus a bonus game, or a basic game versus a basic game, etc. A more detailed description of the available tournament types is explained below with respect to FIGS. 8a-c.

The player may also be able to select the tournament options, at step s236, such as, for example, the length of tournament (time, number of spins, number of bonus rounds, etc.), the time per spin, whether to auto-spin, the wagering amount, the award to play for, the player's tournament name, whether to remain anonymous, an avatar name, etc. Once the tournament type and the tournament options have been determined, the player is assigned to a tournament, at step s240, and then the tournament begins, at step s244.

As described with respect to FIG. 7, a player is given an option as to whether to participate in a wagering game tournament. According to one embodiment, upon initiating the standard wagering game, the player is provided with the option to select to be involved in the tournament mode. According to some embodiments, the player may immediately begin to enroll in a tournament upon selecting tournament mode. According to other embodiments, the player will begin to play the standard game (once or multiple times) and the standard game will be interrupted to notify the player that a tournament is being offered. In some embodiments, the player will then be enrolled in the tournament upon the completion of the standard game they are playing, while in others, the player will be enrolled immediately and return from the tournament to complete the interrupted game.

When the option to select to be involved in a tournament mode is provided and a player has not selected to enter tournament mode, a number of events may occur. For example, the player may be informed when a new tournament begins by a banner located on either the main display 26 or the secondary display 27. Alternatively, the standard game may be interrupted by a tournament notification providing the player with the option to enter the tournament or to continue the standard wagering game. The player may additionally be provided with the option to ignore future tournament notifications, thus, providing the player the ability to play the standard wagering game as though the tournament mode does not exist.

Tournaments may be offered continuously or may only be available upon the occurrence of a predetermined event, such as, for example, after a predetermined period of time has passed, after a player has wagered a specific number of credits, after a particular outcome of the standard game has been achieved, after a predetermined number of bonuses have been earned, etc.

Referring now to FIG. 8a-c, examples of different tournament types will be explained in greater detail. As illustrated in FIG. 8a, a plurality of wagering games 260,270 are provided on a gamin network 40 (FIG. 2). Each wagering game 260,270 is provided on an individual gaming terminal 10. The first standard wagering game 260a and the second standard wagering game 260b each include a basic wagering game 264a,264b and a bonus wagering game 268a,268b, respectively. Similarly, the third standard wagering game 270a and the fourth standard wagering game 270b each include a basic wagering game 274a,274b and a bonus wagering game 278a,278b, respectively.

As illustrated in FIG. 8a, the four wagering games can be used in a plurality of different tournament types 280. For example, the first standard wagering game 260a and the second standard wagering game 260b can form a direct-standard tournament 280a. Similarly, the third standard wagering game 270a and the fourth standard wagering game 270b can also form a direct-standard tournament 280a. In a direct-standard tournament 280a, a standard wagering game competes against the same standard wagering game on a different gaming terminal.

Two additional types of tournaments 280 are the direct-basic tournament 280b and the direct-bonus tournament 280c. In the direct-basic tournament 280b the basic wagering games 264a,264b and 274a,274b are pitted against each other directly in the tournament. Direct tournaments 280a-c allow three types of identical wagering games (standard, basic, or bonus) having identical volatility indexes to be pitted directly against each other. “Volatility index” is a mathematical value that is the industry standard for measuring distribution of sizes and probabilities of slot machine payoffs and is described in further detail in U.S. Pat. No. 6,302,791, which is incorporated herein by reference in its entirety. For example, standard slot machines have a relatively steady payoff progression and, thus, are considered to have low volatility indices, which means that there is a relatively steady progression of many payoff values from the lowest to the highest, with each payoff corresponding probability decreasing as the value of the payoff increases. An example of a reduced volatility index is described in further detail in U.S. patent application Ser. No. 10/872,657, which is incorporated herein by reference in its entirety.

Tournaments 280 may also be offered between wagering games having similar or dissimilar volatility indexes. For example, in FIGS. 8a-b a matched-standard tournament 280d is illustrated between the first standard wagering game 260a and the fourth standard wagering game 270b. In this example, because the volatility index of the standard games, as a whole, is similar, a tournament can be offered between the two games without requiring the adjusting of game outcomes (e.g., increasing/decreasing odds of winning or value of awards). However, in some embodiments where the wagering games that comprise the matched tournament have dissimilar volatility indexes, an adjustment may be made to the game outcome for one of the wagering games so that the volatility indexes are similar or even identical.

Wagering games may be adjusted for participation in tournaments in a variety of ways. For example, as discussed above, special tournament reels can be used to adjust the outcome of the wagering games. The tournament reels may include additional award symbols being displayed thereon such that the likelihood of earning a winning combination is increased. Thus, the look and feel of the wagering game the player is playing remains unchanged while the outcome has been adjusted. In other embodiments, the special tournament reels may include additional or alternative symbols unique to the tournament mode of the wagering game. As an alternative to adjusting the wagering game for tournament play, additional types of handicapping may be utilized. For example, a particular wagering game may begin with an additional number of credits or spins. Alternatively, a player playing a particular wagering game may receive double the standard payouts while participating in the tournament.

FIG. 8b further illustrates matched tournaments 280d-f. For example, a matched-basic tournament 280e may be offered between the first basic game 264a and the fourth basic game 274b , while a matched-bonus tournament 280f may be offered between the first bonus game 268a and the fourth bonus game 278b. While FIGS. 8a-8b have illustrated tournaments 280a-f where every player on a particular team is playing the same wagering game, a mixed tournament 280g may also be offered between teams where the players are playing a plurality of wagering games, as illustrated in FIG. 8c.

In a mixed tournament 280g, each team is composed of a plurality of players where the plurality of players are playing at least two different wagering games. A mixed tournament 280g can include a combination of direct tournaments 280a-c, matched tournaments 280d-f, or both direct and matched tournaments 280a-f within the mixed tournament 280g structure. For example, if the mixed tournament 280g consisted of four players (two players per team) and each player was playing one of the standard games 260a-b,270a-b, the mixed tournament 280g would include two direct-standard tournaments 280a. However, the results of the individual direct-standard tournaments 280a would be consolidated to determine the outcome of the single mixed tournament 280g. Alternatively, if one team were both playing a first standard wagering game 260a (on different gaming terminals), while the second team were playing a second standard wagering game 260b and a fourth standard wagering game 270b, the mixed tournament would include a direct-standard tournament 280a as well as a matched tournament 280d.

As should be apparent from the above discussion, all of the tournaments 280 include a first group of one or more players at one or more gaming terminals competing against a second group of one or more players at one or more different gaming terminals. The scoring and awards for the above-described wagering tournaments will now be described in greater detail. According to some embodiments, during the tournament 280, each player collects an amount of credits based on the outcome of their particular gaming session. The tournament 280 may be scored on a collected amount versus collected amount system. In this system, the number of players on each team during the tournament 280 should be equal. The winning team is determined by combining the collected amounts for each team member on the first team and comparing the overall collected amount to the overall collected amount for the second team. Alternatively, the tournament 280 may be scored on an average collected amount system, wherein the collected amount for each team is totaled and then divided by the number of players on the team. In this system, the number of players on each team during the tournament 280 may be equal or may vary.

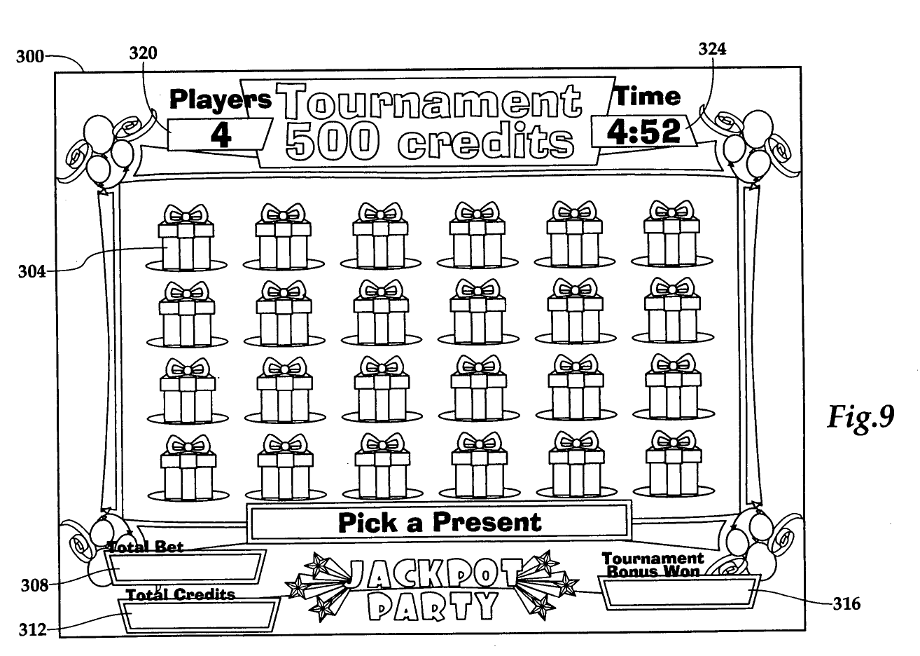

Referring now to FIG. 9, a bonus game screen 300 is shown, according to one embodiment of the present invention. The bonus game screen 300 is similar to the bonus game screen 100 (FIG. 3). The bonus game screen 300 includes an array of markers 304 located in a plurality of columns and rows. The bonus game may be entered upon the occurrence of a special start-bonus game outcome in the basic wagering game, or alternatively, may be selected as the particular wagering game to be played during a tournament between bonus games. The bonus game screen 300 includes a plurality of meters including a “total bet” meter 308 for displaying the total number of credits bet, a “total credits” meter 312 for displaying the total collected credits earned by a player for that particular tournament, and a “tournament bonus won” meter 316 for displaying the number of credits actually awarded to the player for that particular tournament. The bonus game screen 300 may also include a “number of players” meter 320 for displaying the total players involved in the particular tournament and a “time remaining” meter 324 for displaying the time remaining for the particular tournament. The bonus game screen 300 may also include a more detailed tournament meter (not shown) that may contain, for example, the details for each team member (e.g., name, terminal number, terminal location, hometown, etc.), the collect credits value for each player, the tournament award value, etc.

The tournaments 280 may be configured to provide one of a variety of awards to the winning participants. For example, according to some embodiments the tournament 280 is configured to pool the collected values for each team and award the pooled value only to the winning team. In these embodiments, the award may either be divided evenly among the winning team members or may be awarded proportionally to the percentage of the total collected award earned by an individual player. Alternatively, the collected award earned by each player may be provided to that player with the collected awards from the losing team distributed evenly amongst the winning team members.

In other embodiments, the winning team members may receive a special bonus event at the end of the tournament or the standard bonus event with an increase award value or a multiplier included. In yet other embodiments, for direct-standard tournaments 280a, matched-standard tournaments 280d, or mixed tournaments 280g (where only standard games are included), the tournament outcome and award may be based only on the bonus game included with the standard game. For example, the individual players in the tournament may retain all of the awards generated by the basic wagering games, while only the awards for the bonus wagering games are collected for tournament purposes. The collected bonus awards for each team may then be combined and compared to the opposing team's to determine the winning team. Then, the collected bonus awards accumulated for each team may be distributed to the winning team as discussed above.

Alternatively, according to some embodiments, where tournaments include competing wagering games with different volatility indexes, a special award may be provided to the winning team, as opposed to adjusting the game outcomes as discussed above. This special award is independent from the award values accumulated by the players throughout the tournament. These special award embodiments may also be used in tournaments where the tournament winners are determined based on results independent from the award values accumulated by the players (e.g., number of bonus events initiated, etc.)

According to yet other embodiments, the tournament award is funded by a special buy-in by the players to participate in the tournament. In these embodiments, an additional tournament option for the player to select is what amount the player wishes to wager. Players selecting to wager the same amounts are then grouped together to form the tournament.

As should be apparent from the above description the present invention allows a player to play their favorite wagering games in a new wagering environment. Though sitting at an individual gaming terminal, nearly identical to the gaming terminal used for stand-alone games, the player is offered the chance to participate in tournaments. If the player declines, the tournament networked terminals operate substantially the same as the stand-alone models. However, if the player chooses to enroll in one or more tournament, the player may continue to play their favorite game, while adding the additional excitement of person-to-person competition as well as the potential for an increased award to the winner (in some embodiments). Thus, the tournament network of the present invention increases the excitement and adds to the playability of any wagering game.

While the present invention has been described with reference to one or more particular embodiments, those skilled in the art will recognize that many changes may be made thereto without departing from the spirit and scope of the present invention. Each of these embodiments and obvious variations thereof is contemplated as falling within the scope of the claimed invention, which is set forth in the following claims.

What is claimed is:

1. A method of offering a wagering game tournament to a plurality of players on a plurality of gaming terminals located on a gaming network, comprising:
receiving a wager from a first player to play a first standard wagering game on a first gaming terminal;
receiving a wager from a second player to play a second standard wagering game on a second gaming terminal, the second standard wagering game being a different wagering game than the first standard wagering game;
initiating the standard wagering games on the gaming terminals;
providing an option, at the gaming terminals, to the plurality of players to enter a tournament mode;
initiating the wagering game tournament; and
providing the ability to enroll in the tournament once the tournament has been initiated, after the player has selected the tournament mode option.

2. The method of claim 1, wherein the ability to enroll in the tournament results in the immediate enrollment of the player in the tournament, as soon as the tournament has been initiated.

3. The method of claim 1, wherein the standard game is initiated prior to the wagering game tournament.

4. The method of claim 3 further comprising, notifying the player of the initiation of the wagering game tournament.

5. The method of claim 4, wherein the notification interrupts the standard game.

6. The method of claim 5, wherein the player is allowed to complete the standard wagering game prior to enrolling in the wagering game tournament.

7. The method of claim 4, wherein the notification occurs after the completion of the standard game.

8. The method of claim 1, wherein the first player only plays a first bonus wagering game associated with the first standard wagering game and the second player only plays a second bonus wagering game associated with the second standard wagering game, the first and second bonus wagering games being different.

9. The method of claim 8 further comprising, providing an award to at least one of the plurality of players, the award being provided to the at least one player based on the outcome of the first and second bonus wagering games.

10. A method for conducting a wagering game tournament, comprising:
forming a first team including one or more wagering game player, each of the one or more wagering game player interacting with a wagering game displayed on a gaming terminal;
forming a second team including one or more wagering game player, each of the one or more wagering game player interacting with a wagering game displayed on a gaming terminal;
forming the wagering game tournament by placing the first team and the second team in competition with one another, the wagering game tournament including at least two different wagering games;
tracking at least one feature of the wagering games being interacted with by the players, the at least one feature being tracked for both the first team and the second team;
comparing the tracked at least one feature for the first team to the tracked at least one feature for the second team to determine the team that has the greatest number of tracked at least one feature; and
providing an award to each of the at least one player on the team that has the greatest number of the tracked at least one feature.

11. The method of claim 10, wherein the tracked at least one feature is a number of credits earned by the players in the wagering game.

12. The method of claim 11 further comprising, forming a collected award pool by combining the number of credits earned by all of the players on both the first team and the second team.

13. The method of claim 12, wherein the award provided to each of the at least one player on the team that has the greatest number of credits earned is determined by dividing the collected award pool by the number of players on the team that earned the greatest number of credits.

14. The method of claim 12, wherein the award provided to each of the at least one player on the team that has the greatest number of credits earned is proportional to the number of credits earned by each of the at least one players, the award being based on the collected award pool.

15. The method of claim 10, wherein the wagering games are standard wagering games, the standard wagering games including both a basic wagering game and a bonus wagering game.

16. The method of claim 15, wherein the tracked at least one feature is a number of credits earned by the players in the bonus wagering game.

17. The method of claim 16, wherein the credits earned in the basic wagering game by each of the players in the wagering game tournament are awarded to the player that earned the credits.

18. The method of claim 17 further comprising forming a collected award pool by combining the number of credits earned in the bonus wagering games by all of the players in the wagering game tournament.

19. A method for establishing a wagering game tournament, comprising:
receiving a first wager from at least a first player to play a first wagering game and a second wager from at least a second player to play a second wagering game, the second wagering game being a different wagering game than the first wagering game;
initiating the wagering game tournament after the first and second wagers have been received;
forming a first team including at least the first player and a second team including at least the second player;
tracking at least one feature of the first wagering game and the second wagering game, the at least one feature being the same for both the first and second wagering games;
combining all of the tracked at least one feature for each of the at least the first player on the first team and all of the tracked at least one feature for each of the at least the second player on the second team;
comparing the tracked at least one feature for the first team to the tracked at least one feature for the second team to determine the team that has the greatest number of tracked at least one feature; and
providing an award to each player on the team that has the greatest number of the tracked at least one feature.

20. The method of claim 19, wherein the game outcomes are adjusted to create a similar volatility index between the first wagering game and the second wagering game.

21. The method of claim 20, wherein the first wagering game and the second wagering game are both slot machine wagering games having a plurality of standard reels.

22. The method of claim 21, wherein the game outcomes are adjusted by replacing the plurality of standard reels on at least one of the slot machine wagering games with a plurality of tournament reels.

23. The method of claim 19, wherein the first team includes at least two players and the second team includes at least two players.

24. The method of claim 23, wherein the at least two players on the first team are playing different wagering games and the at least two players on the second team are playing different wagering games.

25. The method of claim 24, wherein the tournament being initiated is a mixed tournament.
